(19) United States
(12) Patent Application Publication
(10) Pub. No.: US 2025/0202081 A1
(43) Pub. Date: Jun. 19, 2025

(54) Power Storage Module

(71) Applicant: TOYOTA JIDOSHA KABUSHIKI KAISHA, Toyota-shi Aichi-ken (JP)

(72) Inventor: Hiroyuki NAKAYAMA, Okazaki-shi (JP)

(73) Assignee: TOYOTA JIDOSHA KABUSHIKI KAISHA, Toyota-shi Aichi-ken (JP)

(21) Appl. No.: 18/982,375

(22) Filed: Dec. 16, 2024

(30) Foreign Application Priority Data
Dec. 18, 2023 (JP) 2023-213106

(51) Int. Cl. H01M 50/569; H01M 50/105; H01M 50/474

(52) U.S. Cl. CPC H01M 50/569; H01M 50/105; H01M 50/474

(57) ABSTRACT

A power storage module includes: an electrode assembly including a plurality of electrodes stacked on each other; a laminate exterior package housing the electrode assembly; and a spacer having a sealed internal space and being disposed between an end surface of the electrode assembly and the laminate exterior package. The spacer is made from a material capable of expanding the internal space. An internal pressure of the laminate exterior package is set lower than an internal pressure of the spacer. The spacer expands in such a manner to fill a space between the end surface of the electrode assembly and the laminate exterior package.

### CROSS REFERENCE TO RELATED APPLICATIONS

This nonprovisional application is based on Japanese Patent Application No. 2023-213106 filed on Dec. 18, 2023 with the Japan Patent Office, the entire contents of which are hereby incorporated by reference.

### BACKGROUND

### Field

The present disclosure relates to a power storage module.

### Description of the Background Art

Japanese Patent Laying-Open No. 2020-140874 discloses a laminate-exterior-package battery including an electrode group including a plurality of electrodes stacked on each other, a laminate exterior package housing the electrode group, and a spacer disposed between the electrode group and the laminate exterior package. The laminate exterior package has a flange portion. The spacer is disposed between the flange portion and the electrode group. A corner of the spacer between the outer surface and the upper surface is curved.

### SUMMARY

In the laminate-exterior-package battery described in Japanese Patent Laying-Open No. 2020-140874, wrinkles may be formed at corners of a boundary between a portion of the laminate exterior package covering the outer surface of the spacer and the flange portion.

An object of the present disclosure is to provide a power storage module capable of suppressing the formation of wrinkles in a laminate exterior package.

A power storage module according to one aspect of the present disclosure includes: an electrode assembly including a plurality of electrodes stacked on each other; a laminate exterior package housing the electrode assembly; and a spacer having a sealed internal space and being disposed between an end surface of the electrode assembly and the laminate exterior package, the spacer is made from a material capable of expanding the internal space, an internal pressure of the laminate exterior package is set lower than an internal pressure of the spacer, and the spacer expands in such a manner to fill a space between the end surface of the electrode assembly and the laminate exterior package.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a plan view schematically showing a power storage module according to an embodiment of the present disclosure.

FIG. 2 is a cross-sectional view taken along line II-II shown in FIG. 1.

FIG. 3 is a cross-sectional view taken along line III-III shown in FIG. 1.

FIG. 4 is a cross-sectional view schematically showing a state in which the internal pressure of the laminate exterior package and the internal pressure of the spacer are equal to each other.

FIG. 5 is a cross-sectional view schematically showing a modification of the power storage module.

### DESCRIPTION OF THE EMBODIMENTS

Embodiments of the present disclosure will be described with reference to the drawings. In the drawings referred to below, the same or corresponding members are denoted by the same reference numerals.

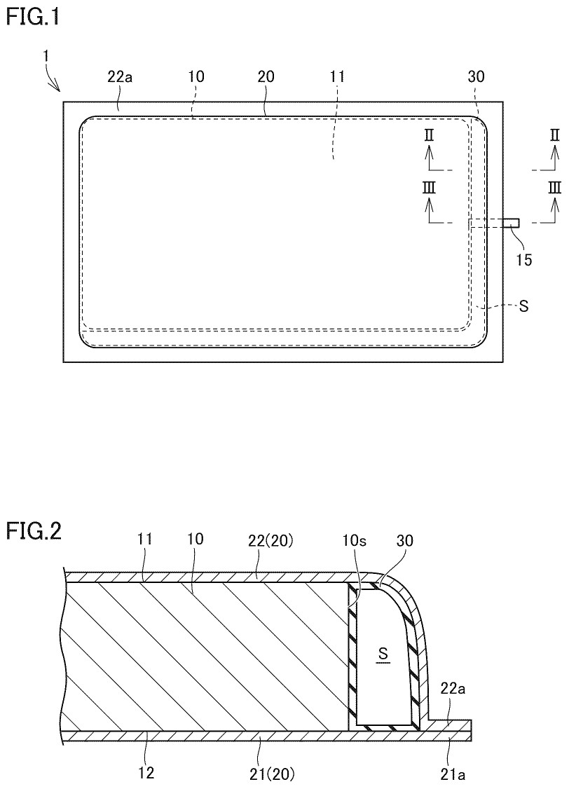

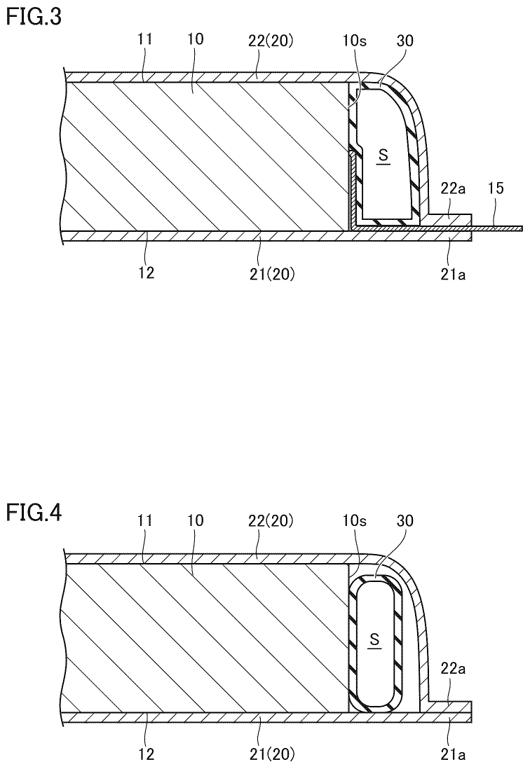

FIG. 1 is a plan view schematically showing a power storage module according to an embodiment of the present disclosure. FIG. 2 is a cross-sectional view taken along line II-II shown in FIG. 1. FIG. 3 is a cross-sectional view taken along line III-III shown in FIG. 1.

As illustrated in FIGS. 1 to 3, the power storage module 1 includes an electrode assembly 10, a voltage detection terminal 15, a laminate exterior package 20, and a spacer 30.

The electrode assembly 10 includes a plurality of electrodes (not shown) stacked on each other, and separators (not shown) disposed between the electrodes. Each of the electrode and the separator is formed in a rectangular shape. Therefore, the electrode assembly 10 is formed in a rectangular parallelepiped shape.

In the present embodiment, each electrode is formed of a bipolar electrode. The electrode assembly 10 has a pair of terminal electrodes 11 and 12 formed on the outermost side in the stacking direction (the vertical direction in FIGS. 2 and 3) of the plurality of electrodes. One of the pair of terminal electrodes 11 and 12 is a positive electrode, and the other is a negative electrode.

The voltage detection terminal 15 detects the voltage of the electrode. For example, the voltage detection terminal 15 is connected to a central portion of the electrode assembly 10 in the stacking direction. The voltage detection terminal 15 is formed of a flexible printed circuit (FPC).

The laminate exterior package 20 houses the electrode assembly 10. The laminate exterior package 20 is hermetically sealed. The laminate exterior package 20 is filled with an electrolyte solution. The laminate exterior package 20 includes a first film 21 and a second film 22. The edge portion 21a of the first film 21 and the edge portion 22a of the second film 22 are welded to each other, so that the inside of the laminate exterior package 20 is sealed. A portion of the first film 21 facing the terminal electrode 11 is made of metal. Similarly, a portion of the second film 22 facing the terminal electrode 12 is made of metal.

As shown in FIG. 1 and FIG. 3, the voltage detection terminal 15 protrudes from the edge of the laminate exterior package 20. As shown in FIG. 3, the voltage detection terminal 15 protrudes from one side (the lower side in FIG. 3) in the stacking direction to the outside of the laminate exterior package 20.

The tab (uncoated portion of the current collector foil) formed on the edge portion of each electrode in the electrode assembly 10 may be connected to the current collector plate, and a part of the current collector plate may protrude from the edge portion of the laminate exterior package 20.

The spacer 30 is disposed between the end surface 10s of the electrode assembly 10 and the laminate exterior package 20. The end surface 10s of the electrode assembly 10 means an outer surface of the electrode assembly 10 in a direction orthogonal to the stacking direction of the plurality of electrodes. The spacer 30 has a sealed internal space S. That is, the spacer 30 is formed in a hollow shape. In the present embodiment, the spacer 30 is formed in a shape in contact with one long side portion and one short side portion of the electrode assembly 10. However, the spacer 30 may be formed in an annular shape surrounding the electrode assembly 10. The spacer 30 is made from a material capable of expanding or contracting the internal space S. The spacer 30 is made from a material having electrolyte resistance. Examples of such a material include ethylene propylene diene rubber (EPDM) and butyl rubber.

As shown in FIGS. 2 and 3, when the internal pressure of the laminate exterior package 20 is lower than the internal pressure of the spacer 30, the spacer 30 expands so as to fill the space between the end surface 10s of the electrode assembly 10 and the laminate exterior package 20.

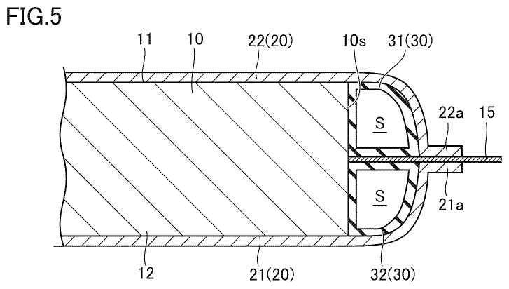

Next, an example of a method of manufacturing the power storage module 1 will be described. For example, the electrode assembly 10 is disposed on the first film 21, and the spacer 30 filled with air under atmospheric pressure is disposed around the electrode assembly 10. Then, the electrode assembly 10 and the spacer 30 are covered with the second film 22. At this time, the electrode assembly 10 is brought close to one side of the long side portion and one side of the short side portion. FIG. 4 shows a state at this time, that is, a state in which the internal pressure of the laminate exterior package 20 and the internal pressure of the spacer 30 are equal to each other.

Thereafter, the edge portion 21a of the first film 21 and the edge portion 22a of the second film 22 are welded to seal the inside of the laminate exterior package 20, and the inside of the laminate exterior package 20 is evacuated. Then, since the internal pressure of the laminate exterior package 20 becomes lower than the internal pressure of the spacer 30, the spacer 30 expands so as to fill the space between the end surface 10s of the electrode assembly 10 and the laminate exterior package 20, as shown in FIGS. 2 and 3.

As described above, in the power storage module 1 according to the present embodiment, since the internal pressure of the laminate exterior package 20 is set to be lower than the internal pressure of the spacer 30 and the spacer 30 expands so as to fill the space between the end surface 10s of the electrode assembly 10 and the laminate exterior package 20, formation of wrinkles in the laminate exterior package 20 is suppressed.

In addition, even in a case where the electrode assembly 10 relatively moves with respect to the laminate exterior package 20, since the spacer 30 functions as a buffer material, breakage of the laminate exterior package 20 is suppressed.

Note that, as illustrated in FIG. 5, the voltage detection terminal 15 may be led out to the outside of the laminate exterior package 20 from the central portion of the electrode assembly 10 in the stacking direction. In this case, the spacer 30 may include a first spacer portion 31 disposed on one side with respect to the voltage detection terminal 15 in the stacking direction and a second spacer portion 32 disposed on the other side with respect to the voltage detection terminal 15 in the stacking direction. Alternatively, the spacer 30 may not be provided in a region overlapping the voltage detection terminal 15 in the stacking direction.

It will be understood by those skilled in the art that the exemplary embodiments and examples described above are specific examples of the following aspects.

### [Aspect 1]

A power storage module including:
an electrode assembly including a plurality of electrodes stacked on each other;
a laminate exterior package housing the electrode assembly; and
a spacer having a sealed internal space and being disposed between an end surface of the electrode assembly and the laminate exterior package, wherein the spacer is made from a material capable of expanding the internal space, an internal pressure of the laminate exterior package is set lower than an internal pressure of the spacer, and the spacer expands in such a manner to fill a space between the end surface of the electrode assembly and the laminate exterior package.

In this power storage module, since the internal pressure of the laminate exterior package is set to be lower than the internal pressure of the spacer and the spacer expands so as to fill the space between the end surface of the electrode assembly and the laminate exterior package, formation of wrinkles in the laminate exterior package is suppressed.

### [Aspect 2]

The power storage module according to Aspect 1, wherein the electrode assembly includes a voltage detection terminal that detects a voltage of the electrodes, the voltage detection terminal protrudes from the laminate exterior package, and the spacer includes:
a first spacer portion disposed on one side with respect to the voltage detection terminal in a stacking direction in which the plurality of electrodes are stacked, and
a second spacer portion disposed on the other side with respect to the voltage detection terminal in the stacking direction.

According to this aspect, formation of wrinkles in a portion of the laminate exterior package overlapping with the voltage detection terminal in the stacking direction is also effectively suppressed.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage module comprising:
an electrode assembly including a plurality of electrodes stacked on each other;
a laminate exterior package housing the electrode assembly; and
a spacer having a sealed internal space and being disposed between an end surface of the electrode assembly and the laminate exterior package, wherein
the spacer is made from a material capable of expanding the internal space,
an internal pressure of the laminate exterior package is set lower than an internal pressure of the spacer, and
the spacer expands in such a manner to fill a space between the end surface of the electrode assembly and the laminate exterior package.

2. The power storage module according to claim 1, wherein
the electrode assembly includes a voltage detection terminal that detects a voltage of the electrodes,
the voltage detection terminal protrudes from the laminate exterior package, and
the spacer includes:
a first spacer portion disposed on one side with respect to the voltage detection terminal in a stacking direction in which the plurality of electrodes are stacked, and
a second spacer portion disposed on the other side with respect to the voltage detection terminal in the stacking direction.
